(19) United States
(12) Patent Application Publication
(10) Pub. No.: US 2019/0324743 A1
(43) Pub. Date: Oct. 24, 2019

(54) CONFIGURATION FILE MANAGEMENT

(71) Applicant: Cloud66 Inc., San Francisco, CA (US)

(72) Inventor: Khashayar Sajadi, El Cerrito, CA (US)

(21) Appl. No.: 16/366,556

(22) Filed: Mar. 27, 2019

Related U.S. Application Data
(60) Provisional application No. 62/662,060, filed on Apr. 24, 2018.

(51) Int. Cl. G06F 8/71; G06F 8/60

(52) U.S. Cl. CPC G06F 8/71; G06F 8/60

(57) ABSTRACT

Systems and methods are presented for defining a configuration policy, checking a configuration file against a policy, and enforcing policies in a deployment process. Some embodiments described in this disclosure may be appropriate to ensure that configuration file parameters are in compliance with a set of rules prior to being deployed. If a draft configuration file is compliant with the rules as defined in a policy, the configuration file may be allowed to be deployed. If a draft configuration file is not compliant with the rules as defined in the policy, the configuration file may be prevented from being deployed.

### CROSS-REFERENCE TO RELATED APPLICATIONS

This application claims the benefit of U.S. Provisional Patent Application No. 62/662,060, filed Apr. 24, 2018, which is hereby incorporated by reference in its entirety.

### FIELD

The present disclosure relates to a method for management of configuration files in computing systems.

### BACKGROUND

Many computing devices and software packages have various settings and parameters that are configurable through a configuration file. For example, servers, storage devices, network appliances, load balancers, software applications, programs, software systems, and software defined infrastructure components may rely on configuration files to work as expected. Configuration files may contain information on how a piece of software or hardware should operate. For example, configuration files may specify operating parameters, database connection strings, server addresses, and other such important information for a piece of software or a device to operate.

Some configuration parameters in a configuration file may have important security and operational consequences for a system. For example, a misconfiguration may render a system inoperable, insecure, or otherwise out of compliance with some standard. These issues are very important for systems which handle sensitive personal or financial information where a misconfiguration could render a system out of compliance with an industry standard or in violation of legal standards.

As an example, recent legislation has increased requirements for oversight and control of personal information for organizations which receive personally identifiable information from users. A misconfiguration in some software systems may introduce security concerns which may increase the risk of data being improperly accessed. For example, a configuration file may include a setting that controls the encryption of data which may either encrypt data or not encrypt data. In a development environment, it may be desirable to disable some data encryption for development and quality assurance purposes. However, the same software package may be required to enable encryption in a production environment to safeguard user data. In this example, if a configuration file is allowed to be deployed to a production environment that includes a setting to disable encryption, the software platform may put user's data in jeopardy which may be in violation of regulations and laws in various jurisdictions.

In another example, various standards settings bodies may establish requirements for systems that handle financial or payment information. A company or organization which is not in compliance with the industry standards may be in violation of contractual obligations to ensure the safekeeping of sensitive financial information. Violation of these standards may result in significant costs in both remedial actions and loss of business relationships. Some software packages may have various settings which are configurable by a configuration file that affect the software package's compliance with these industry standards.

For this reason, many operators of software or hardware components and systems restrict access to configuration of these systems to avoid errors in configuration. One approach is to establish a review process by a trusted group of people so that any configuration files are manually reviewed before being deployed in a production environment. While manual review may reduce the likelihood of errors introduced into configuration files, it is an imperfect solution. The deficiencies of manual review are exacerbated when many systems or devices work in tandem and must have the same or compatible configurations to operate. For example, many individual software systems may work together in a cloud computing environment that all must be similarly configured. A misconfiguration of just one software installation may render an entire system insecure or inoperable. Container-based software deployment technologies may have separate configuration files for many individual software components that further add to the number of total configuration files for a given system. Therefore, manual review of each individual configuration file may be difficult and ineffective at maintaining compliance across a large software system.

### SUMMARY

Presented herein are systems and methods for policy-based configuration file management. Described are systems and methods for defining a configuration policy, checking a configuration file against a policy, and enforcing policies in deployment processes.

In an embodiment, a method for configuration file management is disclosed. A configuration file may be, for example, a set of parameters that control some aspects of the operation of a computing system such as a software package. An operator may define a configuration file policy using a configuration policy manager. The policy may include one or more rules governing the permissible contents of a configuration file. Next, an operator may draft a new configuration file intended for the computing system. A configuration management system receives the draft configuration file and the policy, and takes action based on the degree to which the draft configuration file is compliant with the policy. For example, if the draft configuration file is not compliant with the rules in the policy, the configuration management system may block the deployment of the configuration file to the computing system. If the draft configuration file is compliant with the rules in the policy, the configuration file is allowed to be deployed to the computing system.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

FIG. 1 illustrates an exemplary network environment that may be used in some embodiments;

FIG. 2 illustrates an example configuration management system 200 according to an embodiment;

FIG. 3 illustrates a method 300 for managing configuration files according to an embodiment;

FIG. 4A illustrates an example configuration file according to an embodiment; and

FIG. 4B illustrates an example policy definition according to an embodiment.

### DETAILED DESCRIPTION

In this disclosure, reference is made in detail to specific embodiments. Some of the embodiments or their aspects are illustrated in the drawings.

Many software and hardware systems rely on configuration files for key parameters related to their operation. For example, software packages may read a configuration file when they are started that configures the software to operate in a certain way. Misconfiguration may render a computing system to be insecure or noncompliant with important regulations and standards. Systems and methods for management and validation of configuration files are described herein to provide for granular control over the deployment of configuration files. Embodiments described in this disclosure may be implemented for software or hardware systems that read operating parameters from configuration files.

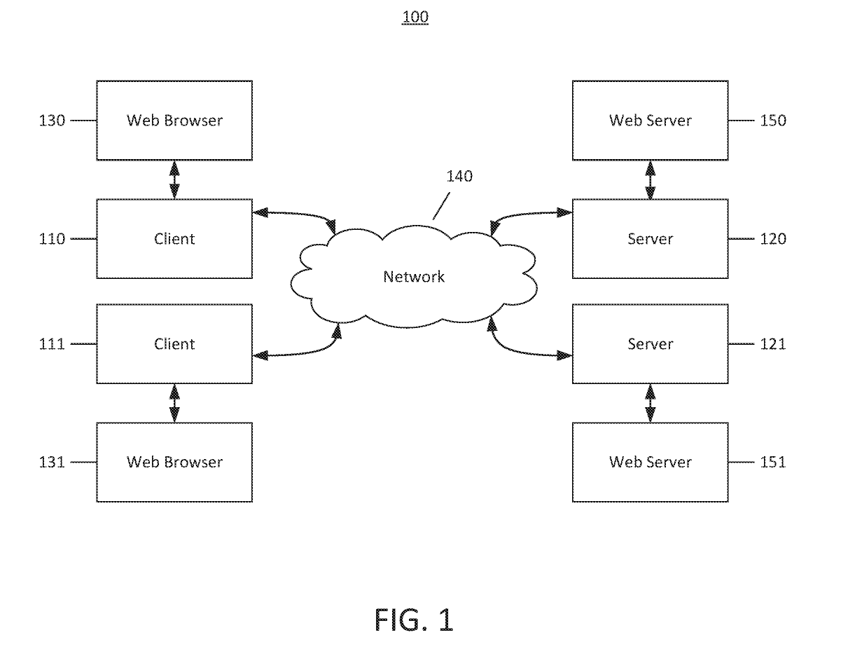

FIG. 1 illustrates an exemplary network environment 100 where some embodiments of the invention may operate. The network environment 100 may include multiple clients 110, 111 connected to one or more servers 120, 121 via a network 140. Network 140 may include a local area network (LAN), a wide area network (WAN), a telephone network, such as the Public Switched Telephone Network (PSTN), an intranet, the Internet, or a combination of networks. Two clients 110, 111 and two servers 120, 121 have been illustrated for simplicity, though in practice there may be more or fewer clients and servers. Clients and servers may be computer systems of any type. In some cases, clients may act as servers and servers may act as clients. Clients and servers may be implemented as a number of networked computer devices, though they are illustrated as a single entity. Clients may operate web browsers 130, 131, respectively for display web pages, websites, and other content on the World Wide Web (WWW). Servers may operate web servers 150, 151, respectively for serving content over the web.

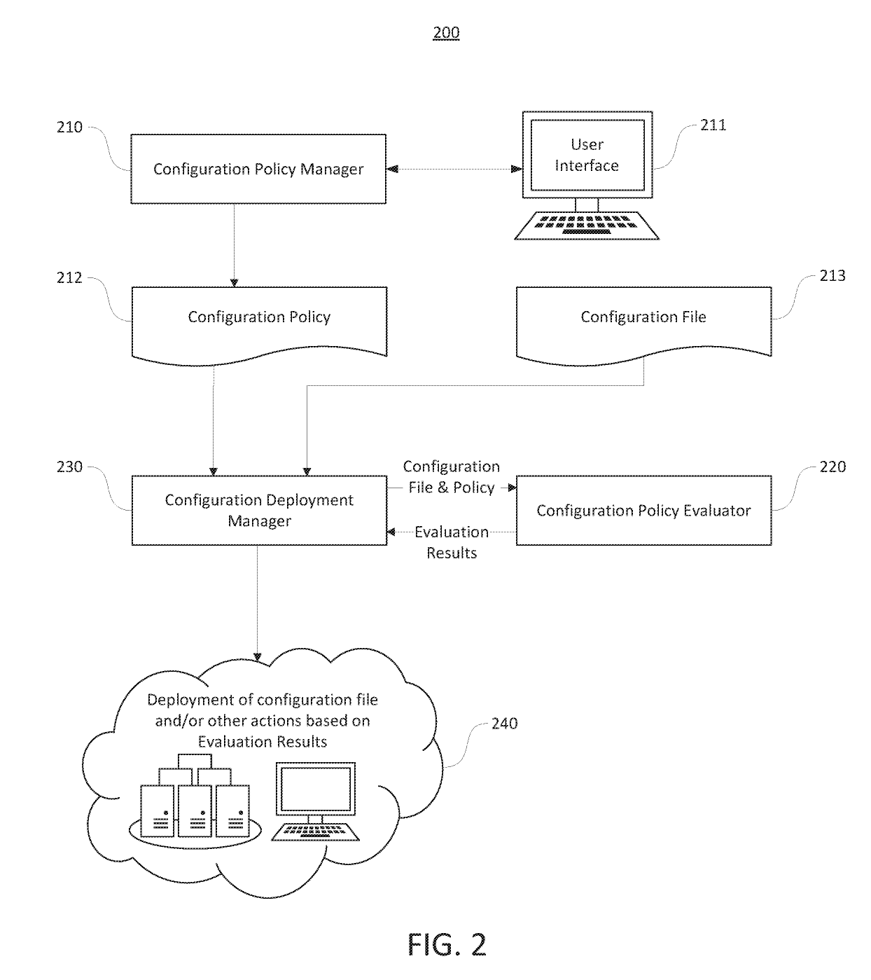

FIG. 2 illustrates an example configuration management system 200 according to an embodiment. Configuration management system 200 includes configuration policy manager 210, configuration policy evaluator 220, and configuration deployment manager 230. Briefly, these three components work together to establish validation and control over configuration files in a computing environment. Configuration policy manager 210 provides operators the tools to define and store configuration file policies. Configuration policy evaluator 220 determines if a configuration file is in compliance with a configuration policy. Configuration deployment manager 230 then, using configuration policy evaluator 220, controls the deployment and usage of configuration files based on policies.

Configuration policy manager 210 provides a user interface 211 for creating, verifying, and storing configuration file policies 212. Configuration file policies may be specified in any suitable programming or scripting language. In some embodiments, configuration file policies may comprise executable software code. For example, configuration file policies may be specified in a programming language such as JavaScript, Ruby, or Python. In some embodiments, configuration file policies may be specified in a non-executable data format that is read and interpreted by other software components. For example, rules in a configuration policy may be stored in serialized data format such as XML, JSON, or YAML. In an embodiment, configuration file policies are specified in a purpose-built programming language sometimes referred to as a domain specific language, or DSL.

The configuration policy DSL provides specific functionality for defining configuration file policies and evaluating configuration files. The configuration policy DSL may be a subset or superset of any other programming language such as JavaScript, Ruby, Python, or similar programming languages. In some embodiments, the configuration policy may include an indication of the computing system it is intended for so that the policy may be associated with configuration files for that computing system at a later time. For example, a configuration may indicate it is a policy for a particular payments processing platform. In this way, other system administrators may unambiguously associate the policy with configuration files for that particular payments processing platform at a later time. In some embodiments, a policy may also indicate the environment that the policy is intended for. For example, the same payments processing platform may have different configurations and therefore a different policy for development, quality assurance, and production environments. In some embodiments, various portions of a single policy may be designated for different environments for the same computing system. In this way, portions of the configuration that are common to multiple deployment environments may be shared while other portions may be varied based on deployment environment. Policies may also specify minimum criteria for the policy to be met or not. For example, a configuration policy may specify that a draft configuration file needs to have a compliance score over a certain threshold in order to qualify as compliant.

In some embodiments, configuration policies are specified as a group of rules. Each rule includes a condition and an action. A condition comprises logic that defines the rule. For example, one condition may be to compare a particular portion of a configuration file to a value. As an example, a condition may retrieve from a configuration file a TCP port number and ensure that it equals 80. If the TCP port number in a configuration file is not equal to 80, this example condition would not be met. Any conditional logic may be included in a configuration policy condition, such as Boolean logic comparisons, text or string manipulation and evaluation, and other such conditional logic. In some examples, conditions may retrieve data from external sources to validate configurations. In an embodiment, a condition may access another software system to retrieve a list of parameters used for validation. For example, a condition may include logic to perform a DNS lookup of a domain name, and use the returned IP addresses to validate an IP address in a configuration file. In another example, a condition may compare parameters of a draft configuration file against a previous version of the configuration file. In this way, configuration files may be adaptable over time without needing to be updated themselves. In another example, condition may retrieve information from two disparate parts of a configuration file and compare them to each other, again providing for general conditions that may be adaptable to various conditions and environments.

In some embodiments, rules also contain an action associated with each condition. The action is what happens if the rule condition is false. For example, one action may be to ensure that the rule condition is met. If it is not, the action will return an indication that the configuration file under evaluation does not meet the policy. Another example action may issue a warning that the rule has failed, but otherwise allow for the configuration file under evaluation to pass the policy. Actions may also include transmitting warnings or failure notifications to other computing systems or users. For example, an action may transmit a warning of potential malicious intent if a vital condition is not met such as an important security or privacy setting. Such warnings or messages may be sent via, for example, email.

Configuration policy manager 210 may provide a graphical user interface (GUI) for creating configuration file policies. Similarly, a text-based interface may be provided for generating and managing configuration file policies in some embodiments. In any embodiments, the configuration policy manager 210 may provide an interface for testing policies against example configuration files and rapidly developing rules and conditions based on existing configuration files. In some embodiments, configuration policy manager 210 may provide interface elements for cryptographically signing a policy. For example, configuration policy manager 210 may enable operators to sign a policy with a trusted certificate that indicates who authorized the policy, when it was authorized, when it expires, and further ensure the authenticity and integrity of the policy for other users.

Configuration policy evaluator 220 receives as input a configuration file 213 and a configuration policy 212. Configuration policy evaluator 220 then evaluates each rule as specified in the received configuration policy against the contents of the configuration file and determines a score or rating of the configuration file based on the configuration policy. In an embodiment, the score is represented as a numerical number between 1 and 100 indicating the degree of compliance with the policy. Some rules may contribute to a score differently than others. For example, some rules may be weighted such that if the rule is not met, the score is set to a lowest value regardless of other rules. This type of weighting may reflect an important rule that cannot be violated according to a policy. Other rules may contribute proportionally to a final overall score, such that the score reflects a percentage of passing rules. In some embodiments, rules may contribute to the score according to the order of the rule in the policy, or other weighting criteria. For example, a rule may specify an explicit weighting or score contribution in the configuration policy.

Configuration deployment manager 230 acts as a gatekeeper for configuration files in a deployment setting. Depending on the results returned by the configuration policy evaluator, the configuration deployment manager may initiate deployment of the configuration file and/or take other actions 240. In an example, the configuration deployment manager may prohibit the deployment of a configuration file to a computing environment if the configuration file is not compliant with a configuration policy set by the administrators of the computing environment. In some embodiments, configuration deployment manager 230 may be integrated with a version control system such as SVN or GIT, a server management platform such as Puppet or Ansible, a scripting language used for deployment control such as Bash or PowerShell, a virtual machine management platform, or a software container management platform such as Kubernetes. In some embodiments, configuration deployment manager 230 may operate as an independent software component on one or more servers that uses operating system interfaces to monitor configuration files. In any embodiment, configuration deployment manager 230 serves to verify compliance of configuration files with configuration file policies and to further affect the deployment of configuration files based on their compliance.

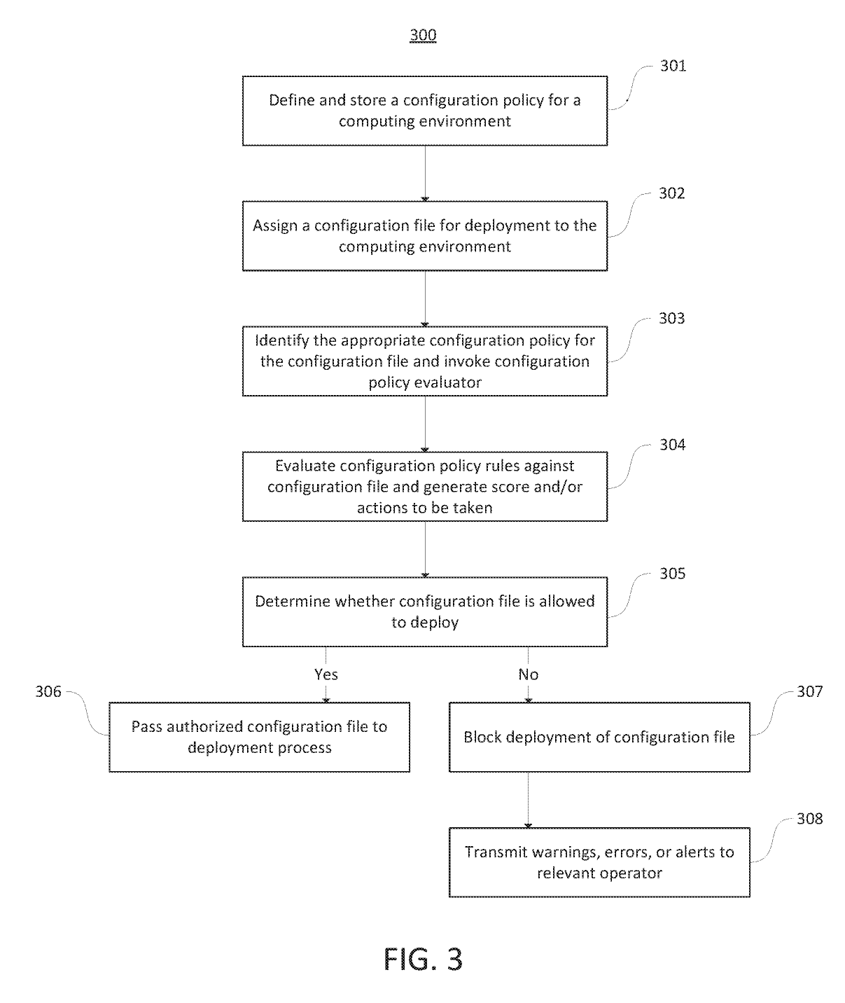

FIG. 3 illustrates a method 300 for managing configuration files according to an embodiment. At step 301, a first operator defines a configuration policy through configuration policy manager 210. In some embodiments, the configuration policy may be cryptographically signed to indicate the first user is responsible for defining the policy. The configuration policy is then stored for later use. At some later time, an operator drafts a configuration file that is intended to be deployed to a particular computing environment. This operator may be the first operator or a second operator. At step 302, the draft configuration file is assigned to be deployed to the particular computing environment. For example, the draft configuration file may be for a payment processing platform in a production environment.

Next, at step 303, configuration deployment manager 230 receives the draft configuration file and the policy. In some embodiments the configuration deployment manager 230 may be integrated with the deployment and orchestration infrastructure used to manage software in the environment. For example, configuration deployment manager 230 may be integrated with a container-based software management system such as Kubernetes. In some embodiments, the policy and draft configuration file are provided by an operator to configuration deployment manager 230. In other embodiments, an operator provides the draft configuration file, and configuration deployment manager 230 identifies and retrieves an appropriate policy for that computing system and deployment environment. In any case, once the configuration deployment manager 230 has identified the draft configuration file and the configuration file policy, configuration deployment manager 230 invokes configuration policy evaluator 220 at step 303 to determine if the configuration file is in compliance with the policy.

Then, configuration policy evaluator 220 iterates over each applicable rule in the policy, checking the conditions against the content of the draft configuration file. For each rule, the associated action is performed by configuration policy evaluator 220. As discussed above, the configuration policy evaluator 220 may then generate a numerical score for the level of compliance of the draft configuration file and return that score to the configuration deployment manager 230 at step 304. In some embodiments, configuration policy evaluator 220 may further indicate that a particular action is to be taken, such as transmitting a notification or alert. In these embodiments, the alert information is also transferred to configuration deployment manager 230 at step 304.

Next, at step 305, configuration deployment manager 230 determines if the draft configuration file is allowed to be deployed to the target system and environment, or not. If the configuration deployment manager 230 determines that the draft configuration file is in compliance with the policy, the draft configuration file is permitted to be deployed. In some embodiments, configuration deployment manager 230 may cryptographically sign the authenticated configuration file to indicate its compliance with the policy. Configuration deployment manager 230 passes the authorized configuration file on to the deployment process at step 306.

However, if configuration deployment manager 230 determines the draft configuration file is not in compliance with the policy at step 305, configuration deployment manager 230 may block deployment of the draft configuration at step 307. In some embodiments, configuration deployment manager 230 may block deployment by directing a deployment management platform such as Kubernetes to fail and stop the deployment process. At step 308, configuration deployment manager 230 may optionally transmit any errors, warnings, or informational messages regarding the blocked deployment to an operator. For example, if a policy is defined by a compliance or legal team in an organization, and a development team attempts to deploy a non-compliant configuration file, the compliance or legal team may be notified of the attempt and apprised of the specific rules and conditions that were not met by the draft file. In this way, configuration deployment manager 230 may serve to facilitate rapid collaboration between teams in an organization.

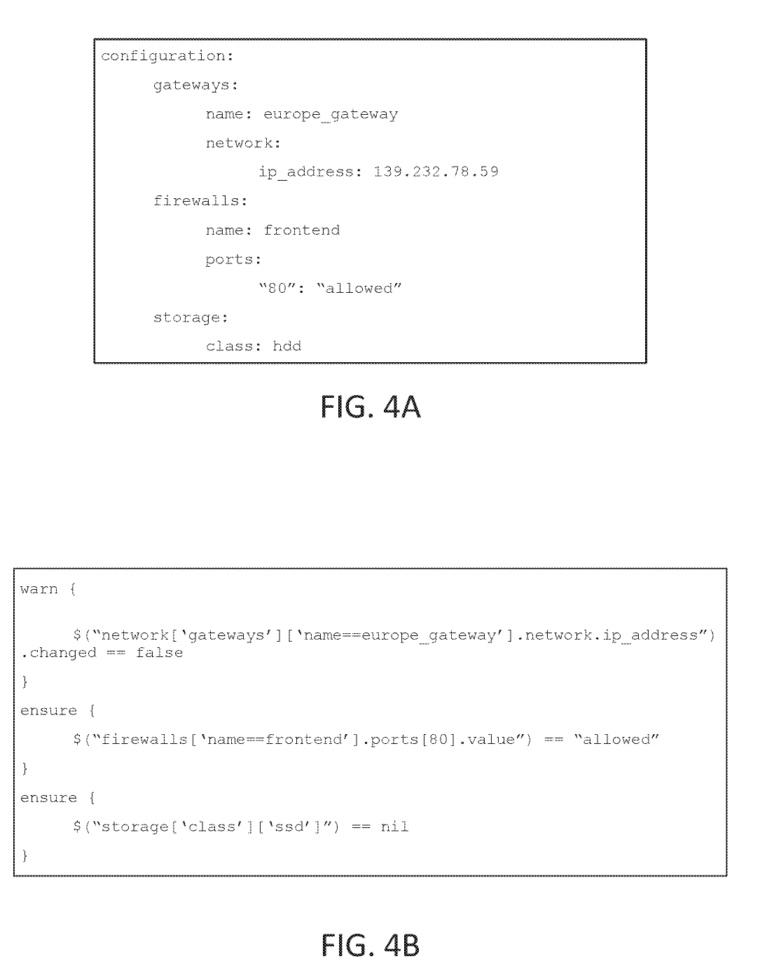

FIG. 4A illustrates an example configuration file and FIG. 4B illustrates an example policy definition intended for the example configuration file. In this example, the example configuration file of FIG. 4A is specified in a YAML markup language. This example configuration specifies parameters for some software system such as a gateway name and IP address, a firewall definition, and an indication of a storage type for an example software system. The example policy of FIG. 4B includes three rules that may operate on the configuration file of FIG. 4A. The rules include one warning condition and two ensure conditions. In some embodiments, a failure of the warning condition will not impede the deployment of the draft configuration file, but a failure of either ensure condition will always indicate a noncompliant configuration.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium and may therefore be considered tangible and non-transitory. Nonlimiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A method for configuration file management, the method comprising:
receiving, by a computing system, a configuration policy defining a set of rules;
receiving, by the computing system, a configuration file including one or more parameters;
evaluating, by the computing system, a compliance of the configuration file with each rule of the set of rules;
determining, based on the evaluating and by the computing system, a compliance score for the configuration file proportional to level of compliance of the configuration file with the configuration policy;
comparing the compliance score to a threshold compliance score; and
in response to comparing the compliance score to the threshold compliance score, transmitting, by the computing system, an instruction to a software deployment system indicating whether or not to allow the configuration file to be deployed,
wherein the instruction indicates the configuration file is not allowed to be deployed if the compliance score is less than the threshold compliance score, and the instruction indicates the configuration is allowed to be deployed if the compliance score is greater than or equal to the threshold compliance score, and
wherein the software deployment system receives the instruction and blocks the deployment of the configuration file if the instruction indicates the configuration file is not allowed to be deployed, and the software deployment system allows the deployment of the configuration file if the instruction indicates the configuration file is allowed to be deployed.

2. The method of claim 1, wherein the compliance score is a numerical score from 1 to 100.

3. The method of claim 1, further comprising:
transmitting, from the computing system to a second computing system, a notification indicating the compliance score and the instruction.

4. The method of claim 1, wherein the set of rules are ranked, and higher ranked rules contribute more to the compliance score than lower ranked rules.

5. The method of claim 1 wherein determining the compliance score for the configuration file proportional to its level of compliance with the configuration policy includes:
setting the compliance score to a minimum score if the configuration file is not in compliance with any rule of the set of rules that is a critical rule.

6. The method of claim 1, wherein the threshold compliance score is specified by the configuration policy.

7. The method of claim 1, wherein the software deployment system controls a deployment of containerized software.

8. The method of claim 1, wherein a rule of the set of rules includes comparing a parameter of the configuration file to a corresponding parameter of a previously deployed configuration file.

9. A configuration file management system, comprising:
a configuration policy database; and
a computing platform including one or more processors and a memory storing instructions that, when executed by the one or more processors, cause the computing platform to:
retrieve, from the configuration policy database, a configuration policy defining a set of rules;
receive a configuration file including one or more parameters;
determine that the configuration file is not compliant with the configuration policy; and
transmit an instruction to a software deployment system instructing the software deployment system to not allow the configuration file to be deployed.

10. The system of claim 9, wherein the memory stores further instructions that, when executed by the one or more processors, further cause the computing platform to:
transmit, to a second computing system, a notification indicating that the deployment was halted.

11. The system of claim 9, wherein the software deployment system controls a deployment of containerized software.

12. The system of claim 9, wherein the configuration policy includes one or more rules which are evaluated in sequence to determine that the configuration file is not compliant with the configuration policy.

13. A method for ensuring compliance between a set of configuration files and a set of configuration policies, the method comprising:
grouping the set of configuration files with the set of configuration policies in a computer system;
for each of the set of configuration files, identifying a corresponding subset of configuration policies of the set of configuration policies;
determining a level of compliance of each of the set of configuration files with an identified corresponding subset of configuration policies;
assigning a numerical compliance score to each of the set of configuration files; and
controlling a software deployment platform based on the numerical compliance score of each of the set of configuration files.

14. The method of claim 13, wherein the numerical score determines the level of compliance that each of the configuration files have with the identified subset of policy definitions.

15. The method of claim 13, further comprising:
transmitting a notification of the compliance of each of the set of configuration files.

16. The method of claim 13, wherein the numerical score is in a range of from 1 to 100.

17. The method of claim 13, wherein controlling a software deployment platform based on the numerical compliance score of each of the set of configuration files comprises:
comparing the numerical compliance score with a threshold score;
generating an instruction based on the comparing; and
transmitting the instruction to the software deployment platform.

18. The method of claim 17, wherein the instruction indicates a configuration file is not allowed to be deployed if the compliance score is less than the threshold compliance score, and the instruction indicates the configuration is allowed to be deployed if the compliance score is greater than or equal to the threshold compliance score.

19. The method of claim 18, wherein the software deployment platform receives the instruction and blocks the deployment of the configuration file if the instruction indicates the configuration file is not allowed to be deployed, and the software deployment platform allows the deployment of the configuration file if the instruction indicates the configuration file is allowed to be deployed.

20. The method of claim 13, wherein at least some of the set of configuration policies contain a set of ranked rules, and higher ranked rules con-tribute more to the compliance score than lower ranked rules.
